(19) United States
(12) Patent Application Publication
(10) Pub. No.: US 2007/0056406 A1
(43) Pub. Date: Mar. 15, 2007

(54) Ring top can opener

(76) Inventor: Terence A. Klein, Twin Lakes, WI (US)

Correspondence Address: WALLENSTEIN & WAGNER, LTD., 311 SOUTH WACKER DRIVE, 53RD FLOOR, CHICAGO, IL, 60606, US

(21) Appl. No.: 11/225,739

(22) Filed: Sep. 13, 2005

(51) Int. Cl. B67B 7/16; B67B 7/00; B25F 1/00

(52) U.S. Cl. 81/3.55; 7/151

(57) ABSTRACT

A ring top container opener for opening a closure of a container. The closure includes a ring member in operable engagement therewith. The ring top container opener comprises a body having a first end, an intermediate portion and a second end. The body comprises a top surface and a bottom surface. The top surface and the bottom surface taper to define an insertion member proximate the second end of the body. The body further comprises a first side surface and a second side surface. The first side surface and the second side surface taper to define the insertion member proximate the second end of the body. A lower lip member is secured proximate the first end and is dimensioned for insertion under a ring member. A first fulcrum surface defined by a first portion of the bottom surface of the body is located between the intermediate portion and the insertion member. A second fulcrum surface defined by a second portion of the bottom surface of the body is located between the first fulcrum surface and the intermediate portion of the body.

### CROSS-REFERENCE TO RELATED APPLICATIONS

None

### FEDERALLY SPONSORED RESEARCH OR DEVELOPMENT

None

### TECHNICAL FIELD

The invention generally relates to a can opener, and more particularly to a can opener for opening a can having a ring-top closure.

### BACKGROUND OF THE INVENTION

Pull ring-type opening tabs are found on a variety of canned goods including soft drinks, other beverages, cat and dog food, nuts, canned meat, powdered milk, and fruit cups. These containers have closures that are crimped along the upper edge of the container wall to form an elevated rim relative to the upper surface of the closure. The seam between the closure and the elevated rim is weakened by a seal line that fully circumscribes the closure just inside of the elevated rim. A ring member is riveted to the closure and has an opening and a rounded end portion diametrically opposed to the opening about the rivet fastener. In its normal position, the ring member lays parallel to and slightly spaced apart from the closure. The rivet operates as a fulcrum for the ring member. Lifting the ring member depresses the rounded end portion against the closure near the seal circumscribing the closure. This causes a preliminary, localized break in the seal circumscribing the closure. The ring member is then pulled upwardly to tear the closure away from the rim extending the break in the seal circumscribing the closure.

However, in the normal position, the ring member is formed flat against the closure making the container difficult to open. As a result, many people have trouble opening containers with pull-tab closures with unaided hands. For example, people afflicted with conditions impairing their manual dexterity, such as limited hand/finger strength, arthritis or injury, find it painful or impossible to open such containers. Individuals with large hands and thick fingertips have difficulty grasping and lifting the thin, flat ring member away from the closure. Those with long fingernails risk breaking their nails while opening such containers. Even healthy people may strain joints in their hands by repeatedly opening this type of container over a period of time. Moreover, an individual may be at risk of injury by the sharp edges of the closure. Also, the ring member may break-off if it is stressed beyond its design limits, thus preventing access to the contents of the container.

While various types of can openers exist to assist in opening pull-tab containers, a continuing need exists for an opener that is compact and easy to use. One type of opener is described in U.S. Pat. No. 5,555,778 issued to Otters et al. Otters describes an opener tool working end, a convexly curved underside portion and a handle fixed to the tool body. Specifically, only a single working end is used to open a container by inserting the working end of the opener under a pull tab ring member, through the opening and over the can rim. The working end is leveraged on the rim and the ring member is lifted to break the seal along the seal line. By utilizing only a single working end, the opener described in Otter requires a large radius of curvature to provide the sufficient leverage to open the container. Consequently, the opener described in Otter is large and takes up considerable room in a standard kitchen drawer.

Another type of can opener is described in U.S. Pat. No. 4,362,071 issued to Coker. Coker describes an opener having a body portion, a working end, and a handle. Similar to Otter, the opener of Coker has a single working end that is used to open a container by inserting the ring member into the working end of the opener. Therefore, the opener requires a wide bottom portion to provide sufficient leverage to open the container. As a result, as with the opener of Otter, the opener described in Otter is large and takes up considerable room in a standard kitchen drawer.

The present invention is provided to solve the problems discussed above and other problems, and to provide advantages and aspects not provided by prior can openers. A full discussion of the features and advantages of the present invention is deferred to the following detailed description, which proceeds with reference to the accompanying drawings.

### SUMMARY OF THE INVENTION

The present invention relates to a ring top container opener for opening a closure of a container. The closure includes a ring member in operable engagement therewith. The ring top container opener comprises a body having a first end, an intermediate portion and a second end. The body comprises a top surface and a bottom surface. The top surface and the bottom surface taper to define an insertion member proximate the second end of the body. The body further comprises a first side surface and a second side surface. The first side surface and the second side surface taper to define the insertion member proximate the second end of the body.

A lower lip member is secured proximate the first end and is dimensioned for insertion under a ring member. The lower lip member can be removably attached to the first end by a fastener. Conversely, the lower lip member can be fixedly attached to the first end.

A first fulcrum surface defined by a first portion of the bottom surface of the body is located between the intermediate portion and the insertion member. The first fulcrum surface is a generally convex curved surface. A second fulcrum surface defined by a second portion of the bottom surface of the body is located between the first fulcrum surface and the intermediate portion of the body. The second fulcrum surface is a generally concave curved surface.

The present invention also relates to a method of opening a closure of a container. The method includes the steps inserting the lower lip member under the ring member, moving the body in a pivotal movement relative to the closure surface causing the ring member to engage the closure surface and break the seal line, inserting the second end through the ring member, moving the body in a pivotal movement relative to the closure surface causing the first fulcrum surface to engage the closure surface and extend the break along the seal line, and moving the body in a pivotal movement relative to the closure surface causing the second fulcrum surface to engage the container rim and extend the break along the seal line.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 illustrates a side view of a can opener of the present invention;

FIG. 2 illustrates a side view of an embodiment of a first end portion of the can opener of the present invention;

FIG. 3 illustrates a perspective view of a first end portion of the can opener of the present invention in a position prior to engaging a ring member on a closure of a container;

FIG. 4 illustrates a perspective view of the first end portion of the can opener of the present invention engaging the ring member on the closure of the container;

FIG. 5 illustrates a perspective view of a second end portion of the can opener of the present invention engaging the ring member on the closure of the container; and,

FIG. 6 illustrates a perspective view of the can opener of the present invention removing the closure of the container.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

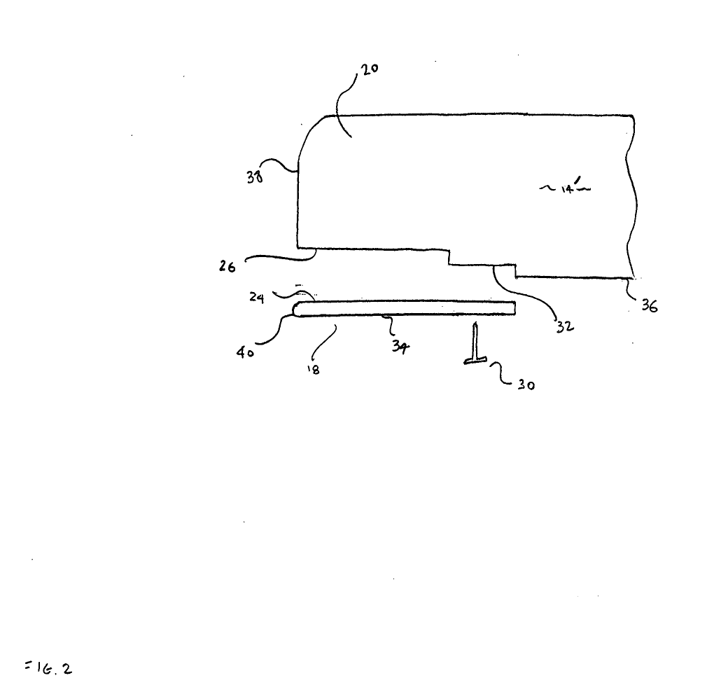

Referring to FIG. 3, a ring top container 42 utilized with the present invention is shown. The container 42 comprises a cylindrical can wall 50 and an end portion 44 having a closure 46 molded therein to seal the contents of the container 42 and form a raised circular rim 52. The seal between the closure 46 and the raised rim 52 is weakened by a circular seal line that circumscribes the end portion 44.

Generally, a ring member 48 is secured by a rivet to a portion of the closure 46 substantially proximate the raised rim 52. The ring member 48 has a ring portion 54 which defines an opening 56. Perferably, the opening 56 is substantially circular. Diametrically opposed to the opening 56 on the ring member 48 is a rounded top portion 58. In FIG. 3, the ring member 48 is shown in its normal condition laying parallel to and slightly spaced apart from the closure 46. The rivet operates as a fulcrum for the ring member 48. Lifting the ring portion 54 depresses the rounded top portion 58 against the closure 46 proximate the seal circumscribing the end portion 44. This causes a preliminary, localized break in the seal circumscribing the end portion 44. The ring portion 54 is then pulled upwardly to tear the closure 46 away from the rim 52 extending the break in the seal circumscribing the end portion 44.

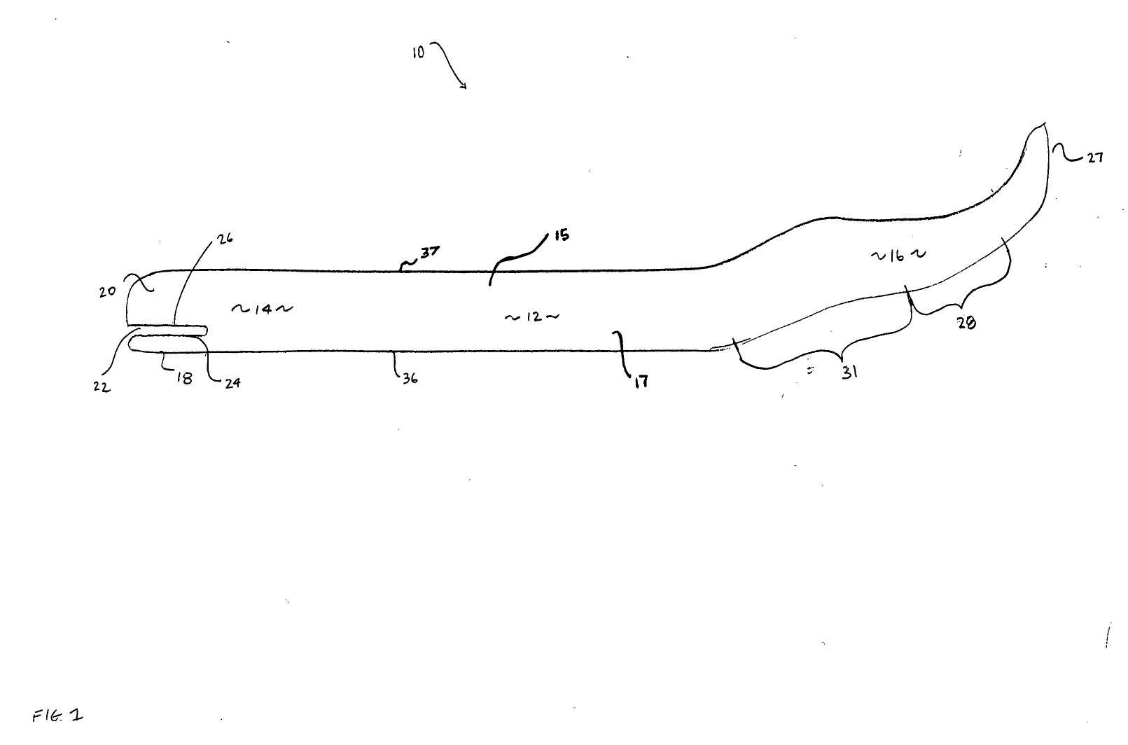

FIG. 1 is a side view of the ring top container opener 10 of the present invention. The opener 10 is utilized to open the closure 46 of the container 42. The opener 10 comprises an elongated body 12 comprising a first end 14, an intermediate portion 15 and a second end 16. Preferably, the elongated body 12 is generally straight and has a width substantially equal to the width of a ring member 48. The body 12 has a top surface 37 a bottom surface 36, and side surfaces 17 traversing the length of the body 12. The body 12, or a section thereof, may be coated with a rubber material for improved gripping of the opener 10. Additionally, the body 12 may have a magnet attached thereto, to provide storage on a magnetic surface, such as a refrigerator.

A lower lip member 18 is secured proximate the distal end of the first end 14. An upper lip member 20 is secured proximate the distal end of the first end 14 in juxtaposition with the lower lip member 18 thereby defining a gap 22 therebetween. The lower lip member 18 and the upper lip member 20 are operably spaced apart such that a ring member can be inserted into the gap 22. The gap 22 comprises a lower gap surface 24 and an upper gap surface 26. Preferably, the gap surfaces 24, 26 are straight and have a width substantially equal to the width of the ring member 48. However, it is contemplated that the width be dimensioned so as to allow the proper leverage during opening of the closure 46. In the same respect, the height of the gap 22 is dimensioned to allow insertion of the ring member 48 therein. Moreover, it is contemplated that the gap surfaces 24, 26 be tapered inwardly of the distal end of the first end 14 creating a stop for the ring member 48.

The second end 16 comprises an insertion member 27, a first fulcrum surface 28 and a second fulcrum surface 31. The second end 16 has a generally curvilinear shape. At the proximate end to the intermediate portion 15 of the body 12, the second end 16 has a width equal to the width of the body 12. The top surface 37, the bottom surface 36 and the side surfaces 17 of the body taper to create the insertion member 27. The insertion member 27 at the distal end of the second end 16 has a point having a width smaller than the diameter of the opening 56 of the ring member 48. The transition between the width of the insertion member 27 and the width of the body 12 creates a stop for limiting passage of the insertion member 27 through the opening 56 of the ring member 48. This stop is located between the first fulcrum surface 28 and the insertion member 27.

An intermediate section of the second end 16 includes the first fulcrum surface 28. The first fulcrum surface 28 is a convexly curved surface located proximate the insertion member 27. During operation, a point on the first fulcrum surface engages the top surface of the closure 46 as a pivot to provide leverage for opening of the container 42. The intermediate section of the second end 16 further includes a second fulcrum surface 31. The second fulcrum surface 31 is a concavely curved surface located proximate the intermediate portion 15 of the body 12. During operation, a point on the second fulcrum surface 31 engages raised rim 52 of the container 42 as a pivot to provide leverage for opening of the container 42.

In one embodiment, the opener 10 is formed as a single unitary apparatus such as plastic, metal, or wood. The unitary apparatus has a recessed portion defining the gap 22 between the lower lip member 18 and the upper lip member 20. The lower gap surface 24 and the upper gap surface 26 are integral surfaces of gap 22 formed at the first end 14 of the opener 10. In another embodiment, as illustrated in FIG. 2, the opener 10 may be assembled from component members. For example, the opener 10 has single unitary component having a body 14, a second end 16, and a first end portion component 14′. The first end portion component 14′ comprises an upper lip member 20 and an upper gap surface 26. The lower lip member 18 is a separate component adapted to be secured to an attachment position 32 of the first end portion component 14′ of the opener 10. The lower lip member 18 is secured to the first end portion component 14′ by means of a fastener 30, such as a nail, screw, staple, adhesive or any fastener contemplated by those of ordinary skill in the art. Preferably, the bottom surface 34 of the lower lip member component 18 is positioned to be level with the bottom surface 36 of the first end portion component 14′. In addition, the vertical surface 38 of the upper lip member 20 is positioned to be level with the vertical surface 40 of the lower lip member 40. Once attached, the lower gap surface 24 is the top surface of the lower lip member component 18.

FIGS. 3-6 illustrate a method in which the opener 10 is used to open a container 42, such as a can. FIG. 3 illustrates the opener 10 prior to engagement with a typical container 42 having a ring member 48. In operation, the lower lip member 18 is inserted under the ring member 48 such that the bottom 36 of the body 12 rests on the rim 52 of the container 42. It is also contemplated that the bottom 36 of the body 12 does not rest on the rim 52. The bottom surface 48 of the ring member rests on the lower gap surface 24. Referring to FIG. 4, the body 12 of the opener 10 is pivoted upwardly thereby causing the rounded top portion 58 of the ring member 48 to initiate the breaking of the seal circumscribing the end portion 44 proximate the ring member 48. The lower gap surface 24 forces the ring member to transitionally progress to a substantially vertical position. The upward movement of the body 12 is continued until ring member 48 is substantially perpendicular to the initial position of the top surface of the closure 46. As downward pressure is applied to the rounded top portion 58 during the upward movement of the body 14, the seal continues to tear.

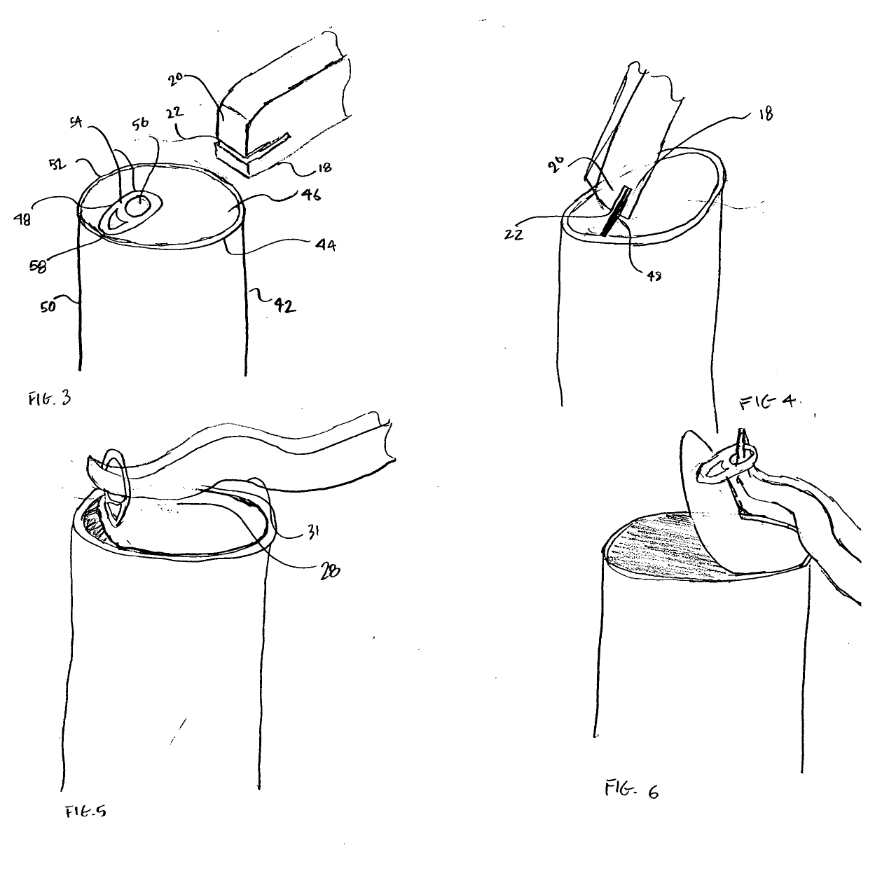

Once the rounded top portion of the ring member completes the initial break of the closure 46 and the ring member 48 is substantially perpendicular to the closure, the first end 14 is removed from the ring member. Referring to FIG. 5 and FIG. 6, the insertion member 27 on the second end 16 of the opener 10 is inserted through the opening 56 of the ring member 48 when it is substantially perpendicular to the top surface of the closure 46. As previously noted, a transition between the width of the insertion member 27 and the width of the body 12 creates a stop for limiting passage of the insertion member 27 through the opening 56 of the ring member 48. A pivot point on the first fulcrum surface 28 engages the top surface of the closure 46 substantially opposite the initial breaking of the seal. At this step, the second fulcrum surface 31 is not engaging the container. Downward force is applied to the body 12 causing the closure 46 to be pulled upwardly away extending the break in the seal circumscribing the end portion 44. As the opener 10 is pivoted in a clockwise direction, the pivot point of the first fulcrum surface 28 engaging the closure transitionally progresses towards the second fulcrum surface 31.

As the clockwise direction of the opener 10 continues, a pivot point on the second fulcrum surface 31 engages the raised rim 52 of the container 42. Once the pivot point on the second fulcrum surface 31 engages the rim 52, the first fulcrum surface 28 no longer acts as a pivot for the opener 10. The pivot point on the second fulcrum surface 31 provides substantial leverage for removing the closure 46 from the container. Further downward force is applied to the body 12 causing the closure 46 to be pulled further upwardly extending the break in the seal circumscribing the end portion 44. An opening is therefore formed within the end portion 44 of the can 42. Immediately after such opening, insertion member 27 remains within the opening 56 of the ring member 54 together with the closure 46. The ring member 54 is discharged from insertion member 27 by inverting the opener 10.

While the specific embodiments have been illustrated and described, numerous modifications come to mind without significantly departing from the spirit of the invention, and the scope of protection is only limited by the scope of the accompanying claims.

What is claimed is:

1. A ring top container opener for opening a closure of a container, the closure including a ring member in operable engagement therewith, the ring top container opener comprising:
a body comprising a first end, an intermediate portion and a second end, the body further comprising a top surface and a bottom surface, the top surface and the bottom surface tapering to define an insertion member proximate the second end of the body;
a lower lip member secured proximate the first end, the lower lip being dimensioned for insertion under a ring member; and,
a first fulcrum surface defined by a first portion of the bottom surface of the body between the intermediate portion and the insertion member.

2. The ring top container opener of claim 1 wherein the body further comprises a first side surface and a second side surface, the first side surface and the second side surface tapering to define the insertion member proximate the second end of the body.

3. The ring top container opener of claim 1 wherein the first fulcrum surface is a generally convex curved surface.

4. The ring top container opener of claim 1 further comprising a second fulcrum surface defined by a second portion of the bottom surface of the body between the first fulcrum surface and the intermediate portion of the body.

5. The ring top container opener of claim 4 wherein the second fulcrum surface is a generally concave curved surface.

6. The ring top container opener of claim 1 wherein the lower lip member is removably attached to the first end by a fastener.

7. The ring top container opener of claim 1 wherein the lower lip member is fixedly attached to the first end.

8. A ring top container opener for opening a closure of a container, the closure including a ring member in operable engagement therewith, the ring top container opener comprising:
a body comprising a first end, an intermediate portion and a second end, the body further comprising a top surface and a bottom surface, the top and bottom surfaces tapering to define an insertion member proximate the second end of the body,
a lower lip member and an upper lip member secured proximate the first end, the lower lip member and the upper lip member being positioned one relative to the other to define a gap therebetween, wherein at least a portion of the gap is sufficiently sized to receive a ring member;
a first fulcrum surface defined by a portion of the bottom surface of the body between the intermediate portion and the insertion member; and,
a second fulcrum surface defined by a portion of the bottom surface of the body between the first fulcrum surface and the intermediate portion of the body.

9. The ring top container opener of claim 8 wherein the body further comprises a first side surface and a second side surface, the first side surface and the second side surface tapering to define the insertion member proximate the second end of the body.

10. The ring top container opener of claim 8 wherein the first fulcrum surface is a generally convex curved surface and the second fulcrum surface is a generally concave curved surface.

11. A method of opening a closure of a container, the closure including a ring member for engagement with the closure, the method comprising the steps of:
providing a ring top can opener comprising:
a body comprising a first end, an intermediate portion and a second end, the body further comprising a top surface and a bottom surface, the top and bottom surfaces tapering to define an insertion member proximate the second end of the body,
a lower lip member and an upper lip member secured proximate the first end, the lower lip member and the upper lip member being positioned one relative to the other to define a gap therebetween, wherein at least a portion of the gap is sufficiently sized to receive a ring member;
a first fulcrum surface defined by a portion of the bottom surface of the body between the intermediate portion and the insertion member; and,
a second fulcrum surface defined by a portion of the bottom surface of the body between the first fulcrum surface and the intermediate portion of the body;
inserting the lower lip member under the ring member;
moving the body in a pivotal movement relative to the closure surface causing the ring member to engage the closure surface and break the seal line;
inserting the second end through the ring member; and,
moving the body in a pivotal movement relative to the closure surface causing the first fulcrum surface to engage the closure surface and extend the break along the seal line.

12. The method of claim 11 wherein the ring top can opener further comprises a second fulcrum edge for engaging a container rim and the method further comprises the step of moving the body in a pivotal movement relative to the closure surface causing the second fulcrum surface to engage the container rim and extend the break along the seal line.
